(19) United States
(12) Patent Application Publication
(10) Pub. No.: US 2019/0326767 A1
(43) Pub. Date: Oct. 24, 2019

(54) ADJUSTABLE WIRELESS CHARGING DEVICE

(71) Applicant: Eagle Fan, Hsinchu (TW)

(72) Inventor: Eagle Fan, Hsinchu (TW)

(21) Appl. No.: 15/955,767

(22) Filed: Apr. 18, 2018

(51) Int. Cl. H02J 7/02; H02J 50/10; F16M 11/06

(52) U.S. Cl. CPC H02J 7/025; F16M 11/06; H02J 50/10

(57) ABSTRACT

An adjustable wireless charging device is provided, comprising: a carrier seat, a first support unit, a second support unit, and a wireless charging module; wherein the first support unit is pivotally connected to the carrier seat, the first support unit is disposed with a retractable arm, the first support unit is pivotally connected to back of the second support unit with the retractable arm; the second support unit has a placement surface; the wireless charging module is disposed inside the second support unit, and the wireless charging module is located at a position corresponding to the placement surface, the carrier seat further comprises a protruding stopper. As such, the regardless the posture the portable electronic device is placed on the present invention, the placement surface can be adjusted to be in complete contact with the portable electronic device to achieve good charging effect.

### TECHNICAL FIELD

The technical field generally relates to a wireless charging device, and in particular, to a charging device for portable electronic device, able to achieve good charging result regardless of the placement posture of the portable electronic device.

### BACKGROUND

As the smart mobile phones and various portable mobile communications or multimedia audio and video devices become ubiquitous, people use these communication devices almost every day and anywhere in everyday life as well as at work. As a result, insufficient power and the need to be charged for the electronic devices could occur at any time. The common approach to charging is to use a connection cable to connect the the portable electronic device to a power supply. The power supply can be a mobile power source or a socket. But the connection cable is often tangled, broken, or damaged. Furthermore, with cable connection, the cable is often accidentally pulled to tripped over, causing the portable electronic device or mobile power source to fall and damaged, which may cause considerable inconvenience to the user.

Therefore, manufacturers have developed a wireless charging device which relies on electromagnetic induction to achieve automatic charging and is currently a popular product. When charging, the sensing area of the wireless charging device must be affixed with the sensing area of the mobile phone to maximize the charging effect.

Therefore, most of the wireless charging devices adopt a special type design. For example, the wireless charging device only provides a specific placement posture for the portable device, such as, with the portable device laid flat or tilted, or may only work with portable electronic devices having the same location of the sensing area, which may cause inconvenience to the user. For example, the charging positions of the tablet computer and the mobile phone are different. As a result, the user must purchase separate wireless charging devices for different devices. It is imperative to devise an adjustable wireless charging device to provide more convenience.

### SUMMARY

The object of the present invention is to provide an adjustable wireless charging device, allowing the portable electronic device to be placed in different posture when charged to achieve good charging effect, as well as applicable to portable electronic devices with sensing area at different locations.

Another object of the present invention is to provide an adjustable wireless charging device, foldable to small size for easy portability or storage.

To achieve the above object, the present invention provides an adjustable wireless charging device, comprising: a carrier seat, a first support unit, a second support unit, and a wireless charging module; wherein the first support unit is pivotally connected to the carrier seat, the first support unit is disposed with a retractable arm, the first support unit is pivotally connected to back of the second support unit with the retractable arm; the second support unit has a placement surface; the wireless charging module is disposed inside the second support unit, and the wireless charging module is located at a position corresponding to the placement surface, the carrier seat further comprises a protruding stopper.

When the present invention is folded, the portable electronic device to be charged can be placed flatly on the placement surface of the second support unit to achieve good charging effect. If the portable electronic device to be charged must be placed in a standing posture, the user can fit the bottom edge of the portable electronic device on the carrier seat against the stopper, then adjust the pivot angle between the first support unit and the second support unit, and adjust the length of the retractable arm so that the wireless charging module is located underneath the sensing area at the back of the portable electronic device to achieve good charging effect. As such, the present invention can be used to achieve the objects of the present invention.

In a preferred embodiment of the present invention, the carrier seat is disposed with a concave accommodating groove, the accommodating groove has a shape matching the retractable arm; when the first support unit and the second support unit are arranged to lay side by side flatly on the carrier seat, the retractable arm is inside the accommodating groove.

In a preferred embodiment, the retractable arm comprises an outer tube and an inner insertion element; the inner insertion element is inside the outer tube, able to move linearly to adjust extension length; the first support unit is pivotally connected to the carrier seat through the outer tube and to the second support unit through the inner insertion element, respectively.

In a preferred embodiment of the present invention, the outer tube has a rectangular cross-section, the inner insertion element has a flat shape; the inner insertion element has a tooth rack, the outer tube is disposed with an elastic tooth at a corresponding position inside the tube; the elastic tooth is engaged with the rack; the outer tube is disposed with two longitudinal slots at place where the elastic tooth is located so that the elastic tooth has an elastic deformation capable of moving for a short distance.

In a preferred embodiment of the present invention, the inner insertion element is further disposed with a protruding latch block, the outer tube is disposed with at least a limiting groove for the latch block to move inside but unable to disengage.

The foregoing will become better understood from a careful reading of a detailed description provided herein below with appropriate reference to the accompanying drawings.

### BRIEF DESCRIPTION OF THE DRAWINGS

The embodiments can be understood in more detail by reading the subsequent detailed description in conjunction with the examples and references made to the accompanying drawings, wherein:

FIG. 1 shows a schematic view of an exemplary embodiment of the present invention in folded state;

FIG. 2 shows a partial dissected view of the structure of the exemplary embodiment of the present invention;

FIG. 3 shows a side view of the exemplary embodiment of the present invention in expanded state;

FIG. 4 shows a first dissected and partial cross-sectional view of retractable arm of the present invention;

FIG. 5 shows a second dissected and partial cross-sectional view of retractable arm of the present invention;

FIG. 6 shows a schematic view of the present invention in use with a portable electronic device in a horizontal tilted posture;

FIG. 7 shows a schematic view of the present invention in use with a portable electronic device in a longitudinal tilted posture.

### DETAILED DESCRIPTION OF THE DISCLOSED EMBODIMENTS

In the following detailed description, for purpose of explanation, numerous specific details are set forth in order to provide a thorough understanding of the disclosed embodiments. It will be apparent, however, that one or more embodiments may be practiced without these specific details. In other instances, well-known structures and devices are schematically shown to simplify the drawing.

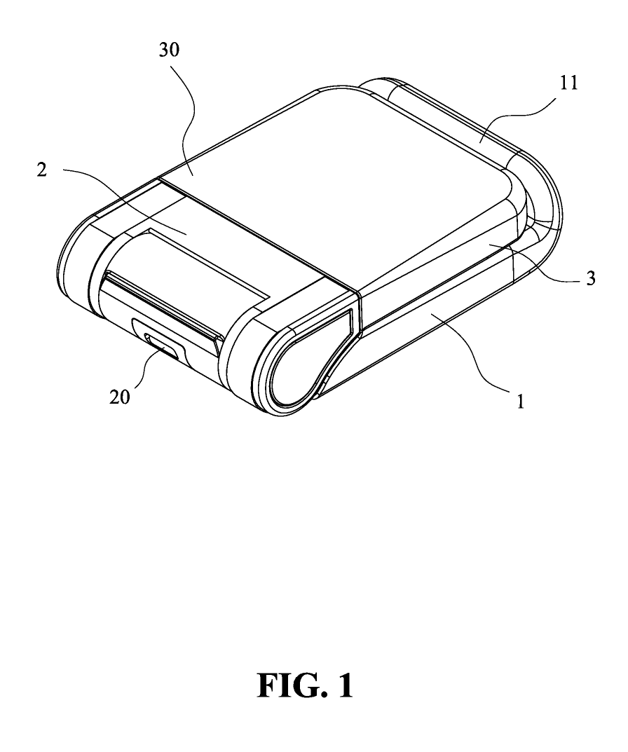

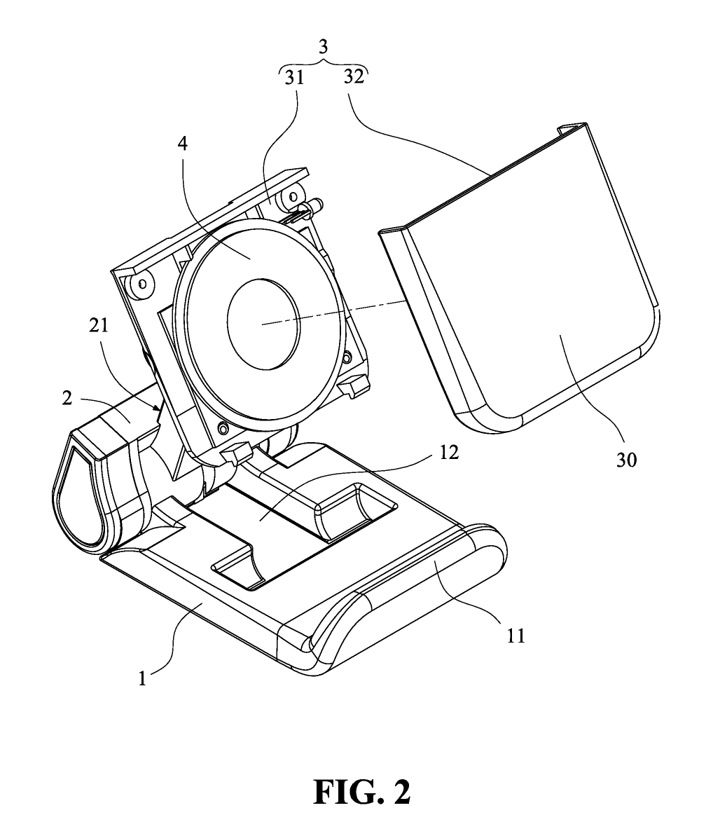

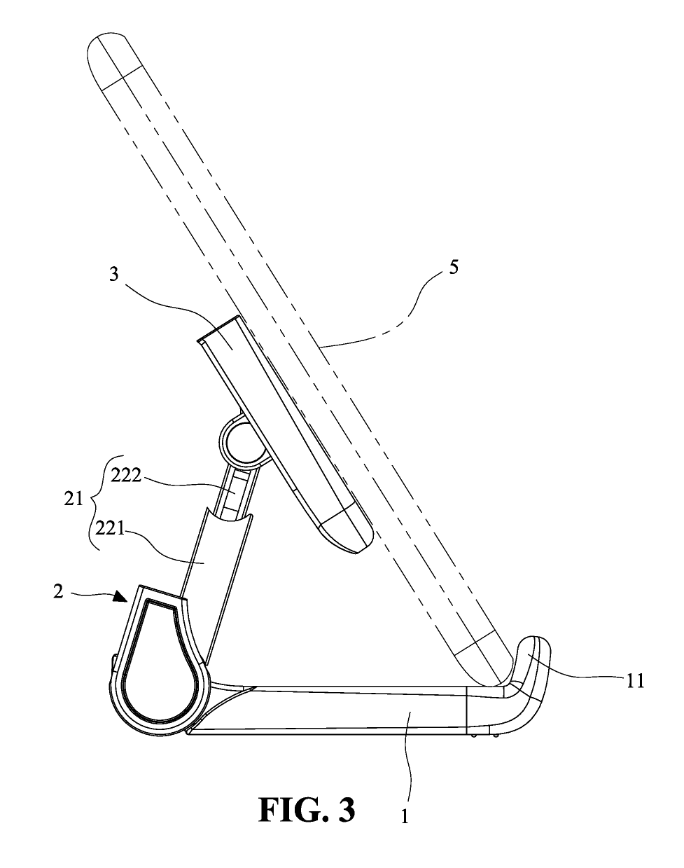

FIG. 1 shows a schematic view of an exemplary embodiment of the present invention in folded state; FIG. 2 shows a partial dissected view of the structure of the exemplary embodiment of the present invention; and FIG. 3 shows a side view of the exemplary embodiment of the present invention in expanded state. The adjustable wireless charging device of the present invention comprises: a carrier seat 1, a first support unit 2, a second support unit 3, and a wireless charging module 4. The first support unit 2 is pivotally connected to the carrier seat 1 so that the angle between the first support unit 2 and the carrier seat 1 can be adjusted. The first support unit 2 is disposed with a retractable arm 21, and the first support unit 2 is pivotally connected to back of the second support unit 3 with the retractable arm 21. The second support unit 3 can also be adjusted for angle with respect to the first support unit 2. The second support unit 3 has a placement surface 30; the wireless charging module 4 is disposed inside the second support unit 3, and the wireless charging module 4 is located at a position corresponding to the placement surface 30. The carrier seat 1 further comprises a protruding stopper 11. As such, when a portable electronic device 5 is placed on the present invention, in either a flat or tilted posture, the placement surface 30 of the second support unit 3 can completely in contact with the portable electronic device 5 to allow the wireless charging module 4 at an optimal charging position.

The following describes the components of the present invention.

The carrier seat 1 has a flat shape, having two ends, with one end pivotally connected to the first support unit 2, and the other protruding to form the stopper 11. The surface of the stopper 11 is made of an anti-slippery material. When in use, the anti-slippery material can prevent the bottom edge of the portable electronic device 5 from sliding. Moreover, the carrier seat 1 is disposed with a concave accommodating groove 12 on the surface facing the first support unit 2. The accommodating groove 12 has a shape matching the retractable arm 21 so that when the first support unit 2 and the second support unit 3 are arranged to lay side by side flatly on the carrier seat 1, the retractable arm 21 is inside the accommodating groove 12.

The first support unit 2 is pivotally connected to the carrier seat 1 so that the angle between the first support unit 2 with respect to the carrier seat 1 is adjustable. With the retractable arm 21 pivotally connected to the second support unit 3, the angle of the second support unit 3 with respect to the first support unit 2 is also adjustable. With two adjustable joints and the adjustable extension length of the retractable arm 21, the wireless charging module 4 inside the second support unit 3 can be positioned to an optimal position to provide charging to the portable electronic device 5 to achieve good charging effect. The pivotal connection mechanism used in the present invention is an adjustable tight coupling, which means that when the external force for adjustment disappears, the relative positions of the two adjusted components are fixed. Such mechanism is well-known, and the details would no be provided here. Moreover, the pivotal connection location between the first support unit 2 and the carrier seat 1 is further disposed with a connector 20 (as shown in FIG. 1). The connector 20 is disposed with wire electrically connected to the wireless charging module 4. The connector 20 is a USB socket, for connecting tan external power source. Also, the location of the connector 20 is not limited to the above embodiment.

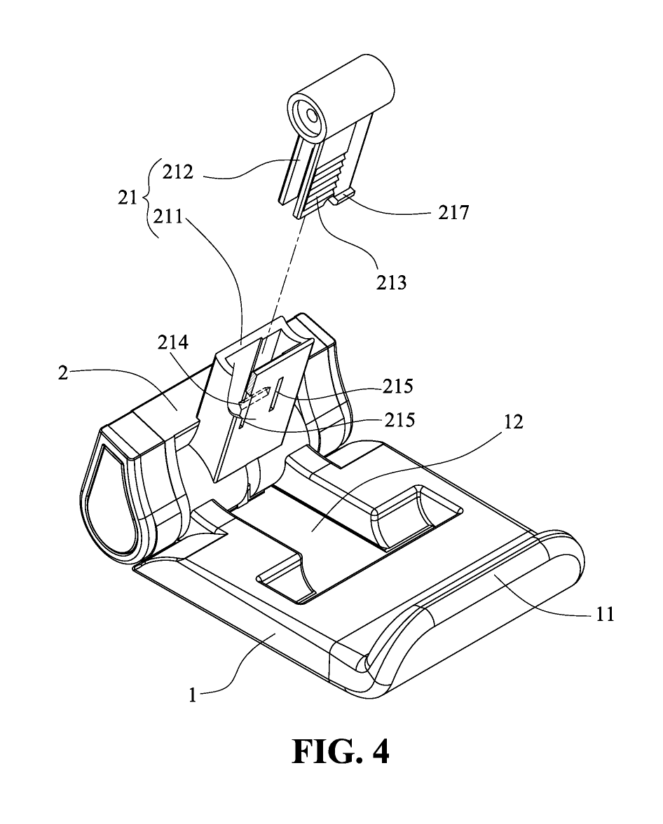

As shown in FIG. 4, the retractable arm 21 comprises an outer tube 211 and an inner insertion element 212; the inner insertion element 212 is inside the outer tube 211, able to move linearly to adjust extension length. The first support unit 2 is pivotally connected to the carrier seat 1 through the outer tube 211 and to the second support unit 3 through the inner insertion element 212, respectively (as shown in FIG. 3). The outer tube 211 has a rectangular cross-section, the inner insertion element 212 has a flat shape; the inner insertion element 212 comprises a tooth rack disposed on a side facing the inner wall of the outer tube 211, the outer tube 211 is disposed with an elastic tooth 214 at a corresponding position inside the tube; the elastic tooth 214 is engaged with the rack 213. The outer tube 211 is disposed with two longitudinal slots 215 at place where the elastic tooth 214 is located so that the elastic tooth 214 has an elastic deformation capable of moving for a short distance. As such, the inner insertion element 212 is adjusted for extension length after being pulled, the elastic tooth 214 is engaged to the rack 213 to lock the position.

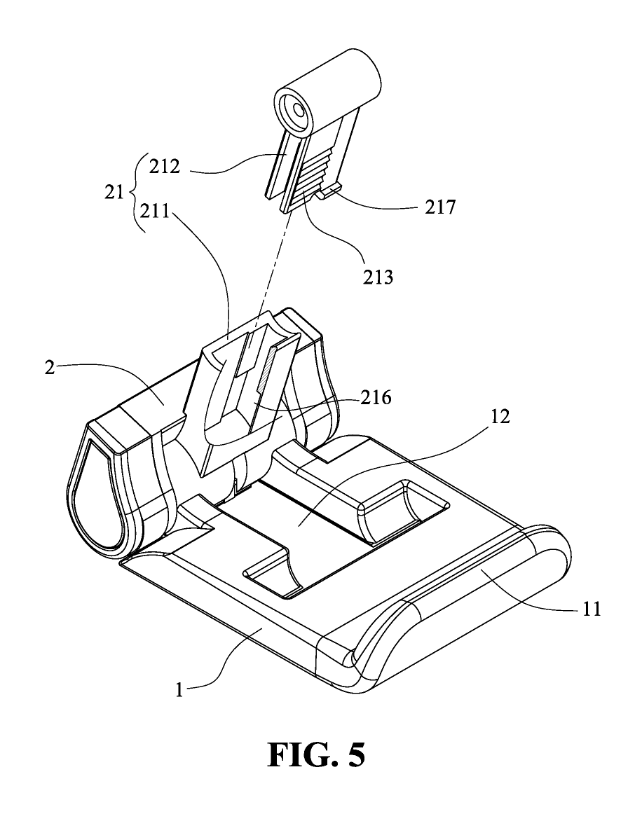

The inner insertion element 212 is inserted into the outer 212, capable of short distance movement but unable to disengage from the outer tube 211. There are various approaches to achieve such a function. The present invention describes an embodiment. As shown in FIG. 5, the outer tube 211 is disposed with at least a limiting groove 216 away from the opening of the tube. The width of the limiting groove is wider than the opening of the tube. The inner insertion element 212 is further disposed with at least a protruding latch block 217. In the present embodiment, two latch blocks are disposed, with only one shown in FIG. 5. When assembling, the two latch blocks 217 are pressed so that the inner insertion element 212 is temporarily deformed at the locations of the two latch blocks 217. When the inner insertion element 212 enters the outer tube 211 to reach the limiting groove 216, the inner insertion element 212 is restored to original shape. Once the inner insertion element 212 is assembled inside the outer tube 211, the inner insertion element 212 is unable to disengage from the outer tube 211.

As shown in FIG. 2, the second support unit 3 comprises a shell 31 and a cover 32, and forming a cavity when the cover 32 covering the shell 31, for housing the wireless charging module 4. The placement surface 30 is located on the surface of the cover 32, corresponding to the wireless charging module 4 inside. The wireless charging module 4 charges the portable electronic device 5, which can be a mobile phone or a small tablet PC. The circuit for wireless charging module 4 is made to match the portable electronic device 5.

The following describes the present invention in actual application.

Each portable electronic device with a wireless charging function has a better sensing area, and the sensing area needs to cooperate with the wireless charging device used to charge. As shown in FIG. 1, the first support unit 2 and the second support unit 3 are adjusted to be placed side by side on the carrier seat 1, and the portable electronic device can be placed on the placement surface 30 of the second support unit 3 in a flat state to be charged.

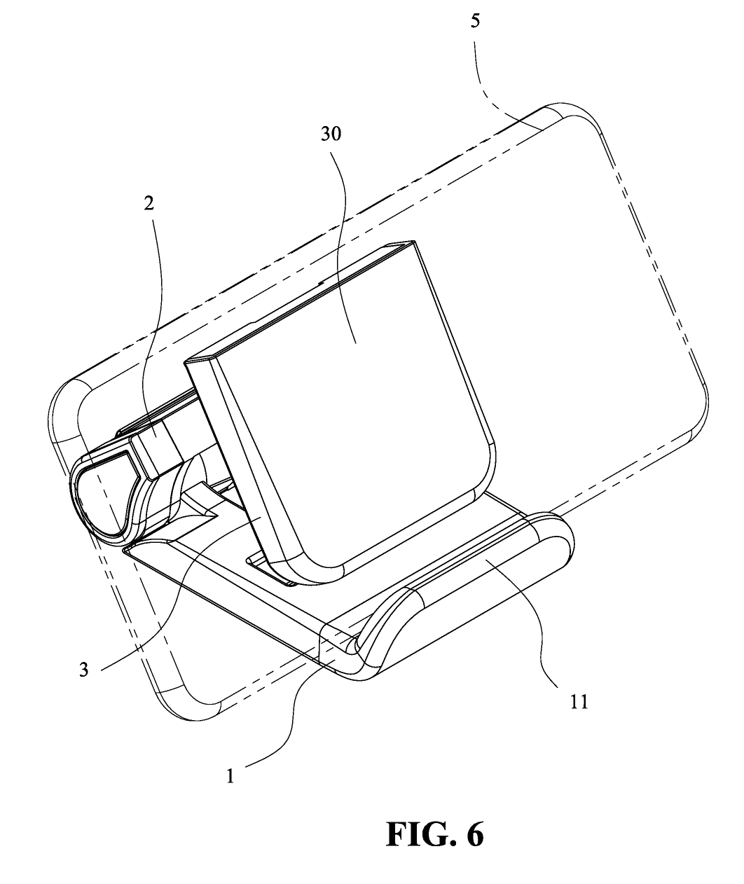

FIG. 6 shows a schematic view of the present invention in use with a portable electronic device in a horizontal tilted posture. In this state, the portable electronic device 5 can be placed in a tilted manner to facilitate the user to perform the charging operation while watching the video played by the portable electronic device. When using, the user first adjusts the angle of the first support unit 2 with respect to the carrier seat 1 (this angle is an acute angle), and then adjusts the angle of the second support units 3 with respect to the first support unit 2. The retractable arm 21 usually does not need to extend in this state, or only extends a short distance. In this state, the stopper 11 of the carrier seat 1 blocks and carries the bottom edge of the portable electronic device 5, the placement surface 30 of the second support unit 3 and the sensing area on the back of the portable electronic device 5 is in direct contact to ensure that the wireless charging module 4 is in the optimal charging position.

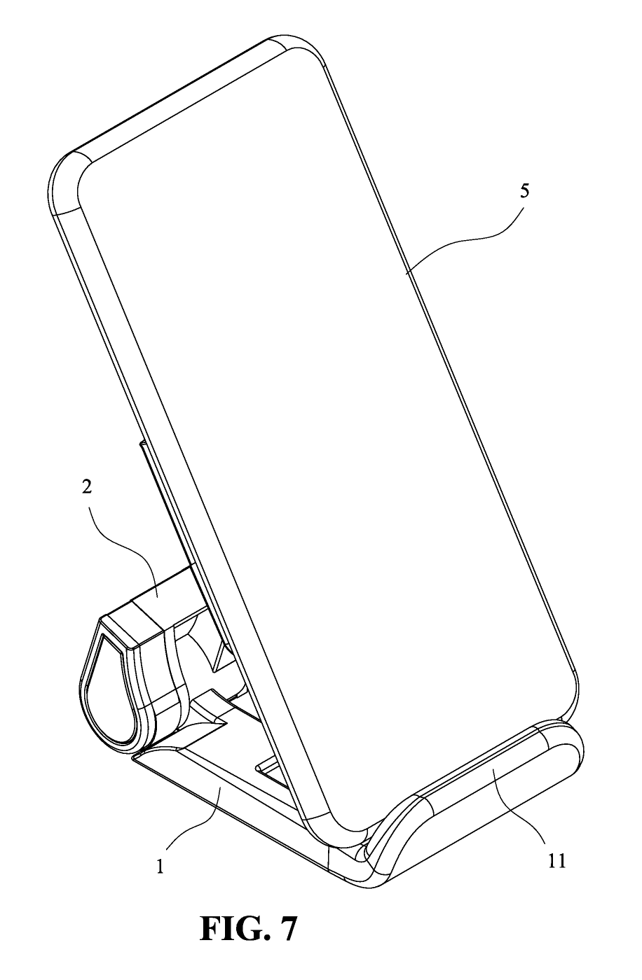

As shown in FIG. 3 and FIG. 7, FIG. 7 shows a schematic view of the present invention in use with a portable electronic device in a longitudinal tilted posture. In this state, the adjustment angle of the first support unit 2 is larger than that of the foregoing embodiment, and the length of the retractable arm 21 is extended more, thereby controlling the position of the placement surface 30 of the second support unit 3 so as to correspond to the sensing area on the back of the portable electronic device 5, and the bottom edge of the portable electronic device 5 is still stopped by the stopper 11. Thus, the portable electronic device 5 is tilted in a nearly upright position, but still obtains good charging effect.

It will be apparent to those skilled in the art that various modifications and variations can be made to the disclosed embodiments. It is intended that the specification and examples be considered as exemplary only, with a true scope of the disclosure being indicated by the following claims and their equivalents.

What is claimed is:

1. An adjustable wireless charging device, comprising: a carrier seat, a first support unit, a second support unit, and a wireless charging module; wherein the first support unit being pivotally connected to the carrier seat, the first support unit being disposed with a retractable arm, the first support unit being pivotally connected to back of the second support unit with the retractable arm; the second support unit having a placement surface; the wireless charging module being disposed inside the second support unit, and the wireless charging module being located at a position corresponding to the placement surface, the carrier seat further comprising a protruding stopper.

2. The adjustable wireless charging device as claimed in claim 1, wherein the carrier seat is disposed with a concave accommodating groove, the accommodating groove has a shape matching the retractable arm; when the first support unit and the second support unit are arranged to lay side by side flatly on the carrier seat, the retractable arm is inside the accommodating groove.

3. The adjustable wireless charging device as claimed in claim 1, wherein the retractable arm comprises an outer tube and an inner insertion element; the inner insertion element is inside the outer tube, able to move linearly to adjust extension length; the first support unit is pivotally connected to the carrier seat through the outer tube and to the second support unit through the inner insertion element, respectively.

4. The adjustable wireless charging device as claimed in claim 3, wherein the outer tube has a rectangular cross-section, the inner insertion element has a flat shape; the inner insertion element has a tooth rack, the outer tube is disposed with an elastic tooth at a corresponding position inside the tube; the elastic tooth is engaged with the rack; the outer tube is disposed with two longitudinal slots at place where the elastic tooth is located so that the elastic tooth has an elastic deformation capable of moving for a short distance.

5. The adjustable wireless charging device as claimed in claim 3, wherein the inner insertion element is further disposed with a protruding latch block, the outer tube is disposed with at least a limiting groove for the latch block to move inside but unable to disengage.

6. The adjustable wireless charging device as claimed in claim 1, wherein the carrier seat has a flat shape, having two ends, with one end pivotally connected to the first support unit and the other protruding to form the stopper.

7. The adjustable wireless charging device as claimed in claim 1, wherein the stopper has a surface made of an anti-slippery material.
